(19) United States
(12) Patent Application Publication
(10) Pub. No.: US 2018/0281842 A1
(43) Pub. Date: Oct. 4, 2018

(54) MOTOR VEHICLE POWER STEERING SYSTEM

(71) Applicant: Ford Global Technologies, LLC, Dearborn, MI (US)

(72) Inventor: Markus Braun, Cologne (DE)

(73) Assignee: Ford Global Technologies, LLC, Dearborn, MI (US)

(21) Appl. No.: 15/941,277

(22) Filed: Mar. 30, 2018

(30) Foreign Application Priority Data
Mar. 31, 2017 (DE) DE102017205516.2

(51) Int. Cl. B62D 5/04

(52) U.S. Cl. CPC B62D 5/0406; B62D 5/0454; B62D 5/0409

(57) ABSTRACT

A power steering system for a motor vehicle having an electric motor and a transmission drivingly connecting the electric motor to a steering column or a tie rod of the motor vehicle. To provide a low-noise and low-friction power steering system with a variable spatial configuration easy to assemble and disassemble the electric motor includes a spherical motor.

### CROSS-REFERENCE TO RELATED APPLICATIONS

Not Applicable.

### BACKGROUND OF THE INVENTION

### 1. Field of the Invention

The invention relates to a power steering system for a motor vehicle, and more specifically to a steering system including an electric motor connected to a steering component of the motor vehicle.

### 2. Description of Related Art

A conventional electromechanical power steering system (Electric Power Assisted Steering; EPAS) includes an electric motor having a cylindrical stator and a cylindrical rotor. An axis of rotation of the rotor is identical to an axis of symmetry or longitudinal central axis of the stator. The rotor is normally rotatably mounted with two radial bearings.

To create steering assistance, the electric motor connects, typically through a drive mechanism, to a steering component, such as a steering column or a tie rod, of a motor vehicle. The axis of rotation of the rotor coincides with an axis of rotation or longitudinal central axis of a drive shaft connected to the rotor. The electric motor lies on the longitudinal central axis of the drive shaft and extends by a certain extent transversely thereto.

Convention radial bearings used to rotatably bear or support the rotor of the electric motor can cause noise during operation of the power steering system. The bearings have a certain degree of friction, which is undesirable in steering systems. In the case of repair, the entire part of the power steering system associated with the electric motor must generally be replaced, making repair costly.

### SUMMARY OF THE INVENTION

A power steering system for a motor vehicle, having an electric motor and a transmission drivingly connecting said electric motor a steering component of the power steering system wherein the electric motor is a spherical motor having a spherical rotor and a semi-spherical stator.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic side view of an exemplary embodiment of a power steering system according to the invention;

FIG. 2 is a schematic elevational view of the power steering system of FIG. 1.

FIG. 3 is a schematic side view, with portions removed, illustrating a detail of the power steering system of FIGS. 1 and 2.

FIG. 4 is a schematic side view of a further exemplary embodiment of a power steering system in a first state.

FIG. 5 is a schematic side view of the power steering system of FIG. 4 in a second state.

### DETAILED DESCRIPTION OF THE PREFERRED EMBODIMENTS

The following description of the preferred embodiment(s) is merely exemplary in nature and is in no way intended to limit the invention, its application, or uses.

In the figures, identical components and components with an identical function are provided with the same reference numbers.

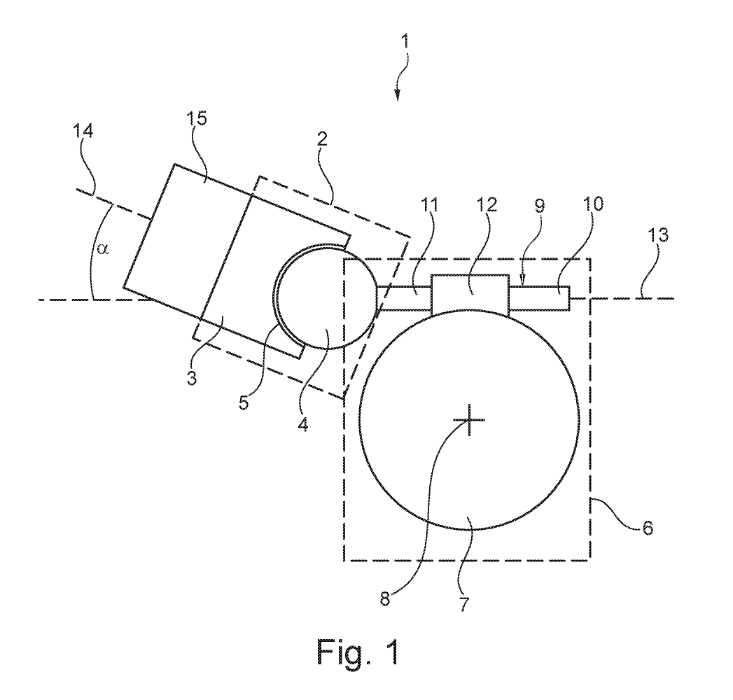

FIG. 1 is a schematic view of an exemplary embodiment of a power steering system 1 for a motor vehicle, not shown.

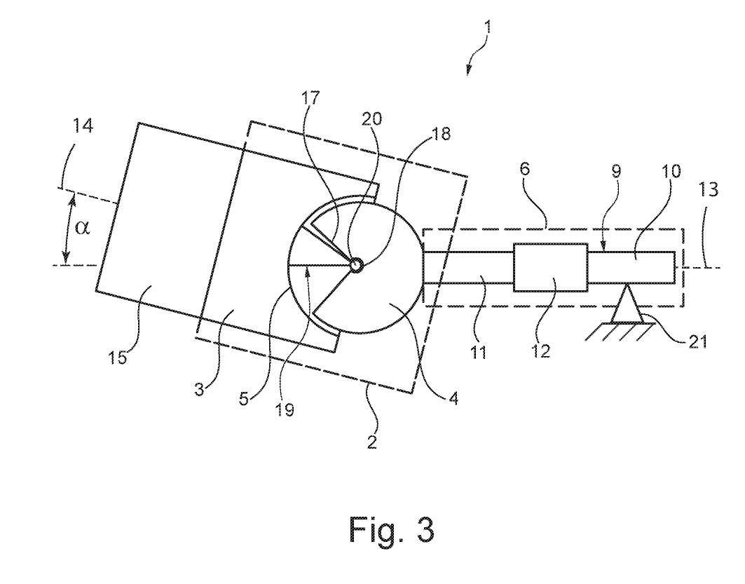

The power steering system 1 includes an electric motor 2. In one embodiment, as shown in FIG. 3, the electric motor 2 is a spherical motor having a stator 3 and a rotor 4 formed in a spherical configuration. The rotor 4 engages a semi-spherical recess 5 formed on the stator 3 with the rotor 4 guided in an articulated manner on the stator 3. The stator 3 includes electrically actuated electric magnets, not shown, and the rotor 4 includes permanent magnets, not shown. An axis of rotation 13 of the rotor 4 and an axis of symmetry 14 of the stator 3 are offset at an obtuse angle α.

The power steering system 1 further includes a transmission 6 connecting the electric motor 2 to a steering column, not shown, of the motor vehicle. In the exemplary embodiment, the transmission 6 is a worm drive including a worm wheel 7 connected in a rotationally conjoined manner to the steering column and rotatable about an axis of rotation 8. A worm, seen generally at 9, connects in a rotationally conjoined manner to the rotor 4 of the electric motor 2. The worm 9 includes a shaft portion 10, facing away from the electric motor 2, guided on a stationary bearing, not shown. The worm 9 also having a shaft portion 11 connected in a rotationally conjoined manner to the rotor 4. An engagement portion 12 of the worm 9, arranged between shaft portions 10 and 11, has at least one screw thread, not shown, and engages the worm wheel 7.

The power steering system 1 may include a housing, not shown, connected to the stator 3, enclosing a portion of rotor 4, with a housing opening through which worm 9 runs. The housing connected with a mechanical connection, for example, an interference fit or a force-fit, a bayonet fitting, not shown, or a threaded connection to the stator 3. The position of the housing on the stator 3 can vary relative to the stator 3 along the axis of symmetry 14 of stator 3. As shown, the housing can be formed wherein the angle α between the axis of rotation 13 of the rotor 4 and the axis of symmetry 14 of the stator 3 can be varied by a variation of the position of the housing relative to the stator 3.

The power steering system 1 includes control electronics 15 controlling the electric motor 2. The control electronics 15 are fastened to the stator 3. The control electronics 15 together with the electric motor 2 form a space-saving compact structural unit.

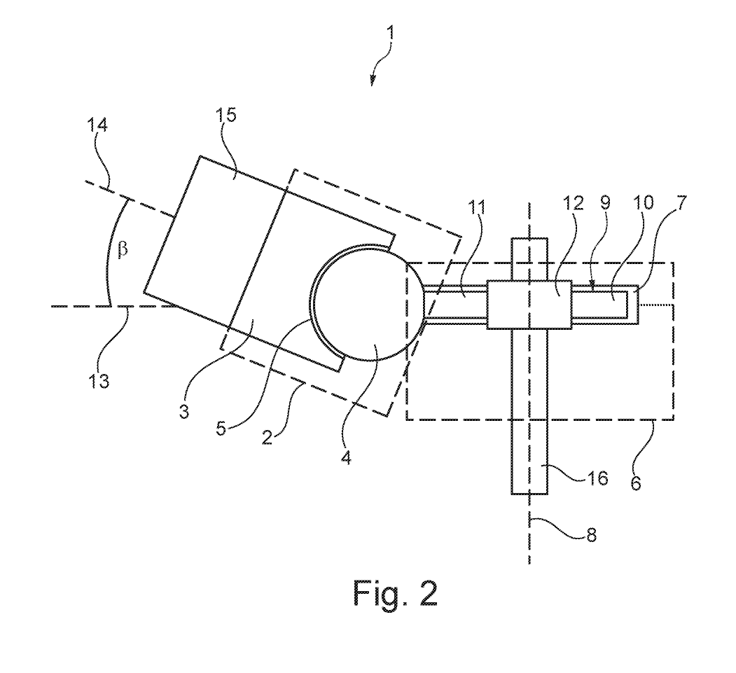

FIG. 2 illustrates a further schematic view of the power steering system 1 shown in FIG. 1. The axis of rotation 13 of the rotor 4 and the axis of symmetry 14 of the stator 3 of the power system 1 are, in a view rotated by 90° from FIG. 1, arranged at an obtuse angle β. FIG. 2 also illustrates a steering component of the steering system, in one example, a steering column 16 of the motor vehicle, not shown, extending along the axis of rotation 8 of the worm wheel 7. The worm wheel 7 connected in a rotationally conjoined manner to the steering column 16. Reference is otherwise made to the above description in relation to FIG. 1 to avoid repetition.

The exemplary embodiment shown in FIGS. 1 and 2 includes a transmission 6 including, the worm 9 connected in a rotationally conjoined manner to the rotor 4 of the electric motor 2 and a worm wheel 7 connected in a rotationally conjoined manner to steering column 16. Other embodiments may include the transmission 6, instead of the worm wheel 7 connected to steering column 16, connected to other steering components, for example, a steering rack connected to a tie rod of the steering or formed as a tie rod. If so, in FIGS. 1 and 2 the reference number 7 would designate the tie rod and reference number 16 would designate the steering rack.

FIG. 3 shows, in a schematic view, details of the power steering system 1 shown in FIGS. 1 and 2, with the worm wheel 7 removed. In particular, the rotor 4 has a recess 17 extending up to the center of the rotor 4 and ending there in a spherical receptacle 18. A ball pin 19 is arranged on the stator 3, the ball pin 19 extends within the recess 5 of the stator 3 and has a bearing ball 20 at the free end thereof. The bearing ball 20 engaging and arranged in the spherical receptacle 18 of the rotor 4. This arrangement results in the rotor 4 three-dimensionally, movably mounted on the stator 3, wherein movability is restricted only by the conical shape of ball pin 19 and the shape of the recess 17 of the rotor 4. The shaft portion 10 of the worm 9, or the worm 9, is rotatably mounted on a stationary bearing 21. The stationary bearing 21 may be a radial bearing and, may function like an axial bearing. To avoid repetition, reference is made to the above description in relation to FIGS. 1 and 2.

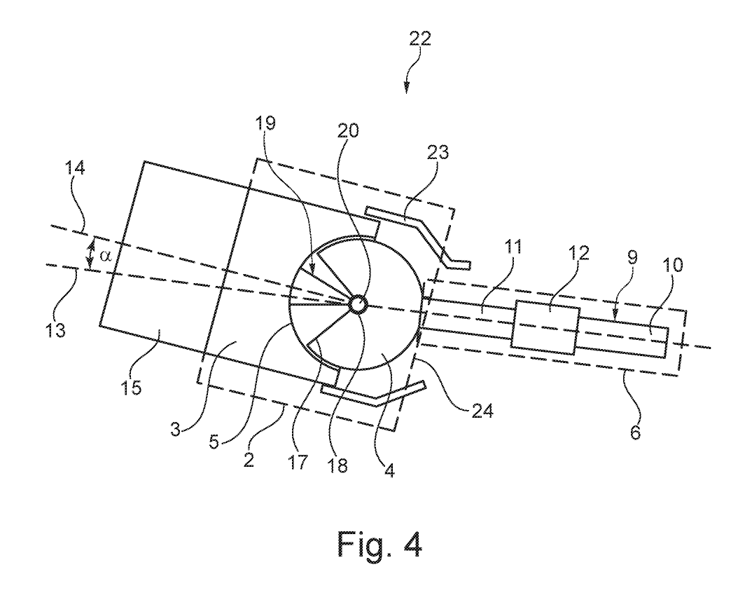

FIG. 4 shows a schematic view of a further exemplary embodiment of a power steering system 22 for a motor vehicle, not shown, in a first state similar to that shown in FIG. 1 with the worm wheel 7 removed. The power steering system 22 differs from the exemplary embodiment shown in FIGS. 1-3 in that it shows a housing 23 connected to the stator 3 of the electric motor 2. The housing 23 encloses a portion of the rotor 4 of the electric motor 2 and has a housing opening 24 through which the worm 9 of the transmission 6 runs. To avoid repetition, reference is made to the above description in relation to FIGS. 1-3.

The housing 23 is connected to the stator 3 with a mechanical fit. In one embodiment, the housing 23 is screwed on, or threadably engages, the stator 3 through an outer thread, not shown, on the outside of the stator 3 and an inner thread, not shown, on the inside of the housing 23. The housing 23 tapers inwardly in the direction of housing opening 24.

Because of the screw or threadable connection between the housing 23 and the stator 3, the position of the stator 3 may vary relative to the housing 23 along the axis of symmetry 14 of stator 3, wherein the housing 23 is formed such that the angle α between the axis of rotation 13 of the rotor 4 and the axis of symmetry 14 of the stator 3 varies with the position of the stator 3 relative to the housing 23. FIG. 4 shows a first state of the power steering system 22 wherein the stator 3 is positioned in the housing 23 in a retracted position. The more the stator 3 is retracted the closer the respective axes 13 and 14 come to being coincidental.

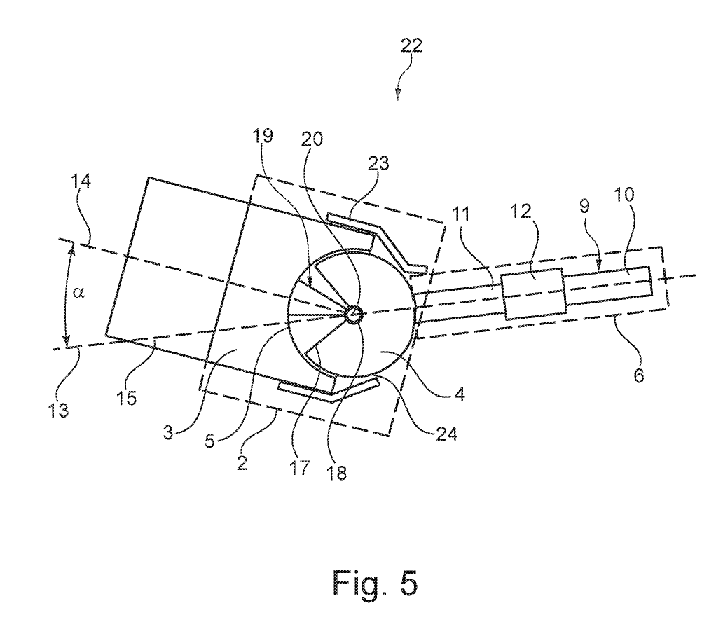

FIG. 5 shows a schematic view of the power steering system 22 similar to that shown in FIG. 4 in a second state wherein the stator 3 is positioned in the housing 23 in an advanced position. Both FIG. 4 and FIG. 5 are shown in an exaggerated state to illustrate the change in obtuse angle α as the stator 3 moves with respect to the housing 23. As explained, movement of the stator 3 along the stator 3 axis of symmetry 14 moves the axis of rotation 13 of the rotor 4 with respect to the axis of rotation 8 of the worm wheel or tie rod 7. Changing the relative positions of the respective axes 13, 8 adjusts the free play or engagement between the worm 12 and worm wheel 7.

The exemplary embodiment provides a low-noise and low-friction power steering system having a variable spatial configuration. The configuration of the power steering system can correspond to configurations of the motor vehicle, and vice versa, even if reference is not explicitly made to this in detail.

The power steering system 1 includes at least one electric motor 2 and at least one transmission 6 drivingly connecting the electric motor 2 to a steering column or a tie rod of the motor vehicle, wherein the electric motor 2 may be a spherical motor.

Because the electric motor is formed as a spherical motor or spherical electric motor the transmission 6 connects, via the rotor 4 of the electric motor 2, in an articulated manner to the stator 3 of the electric motor 2. As a result, the stator 3 can be arranged in such a manner that its axis of symmetry or longitudinal central axis 14 is not identical to an axis of rotation 13 of the rotor 4 or a drive shaft connected in a rotationally conjoined manner thereto. The stator 3 can be arranged asymmetrically in relation to the axis of rotation of the drive shaft. This makes it possible to arrange the stator 3 at a point in the motor vehicle having adequate installation space making it unnecessary to create additional installation space for the stator 3. The stator 3 need not be arranged correspondingly asymmetrically in relation to the axis of rotation 13 of the rotor 4 if the installation space allows such a configuration of the power steering system 1. Because of the articulated connection between the stator 3 and the rotor 4, the power steering system 1 has a variable spatial configuration that can be adapted to available installation space in a simple manner.

The spherical electric motor 2 according to the exemplary embodiment, includes movably mounting the rotor 4, with a ball pin 19, on the stator 3, wherein a longitudinal central axis of the ball pin 19 is identical to the axis of symmetry 14 or longitudinal central axis of the stator 3. The spherical electric motor does not have a conventional radial bearing for rotatable bearing of the rotor 4. Supporting the rotor 4 on the ball pin 19 provides quieter operation of the power steering system 1 in comparison with a conventional bearing or support via radial bearings. Supporting the rotor 4 on the ball pin 19 has less friction compared to conventional bearing or support via radial bearings.

If defective or damaged parts occur in the power steering system 1, in particular the electric motor 2, or on a vehicle component, for example, the steering column, the steering gear or the like, on which the electric motor is arranged, the rotor 4 of the spherical electric motor 2 can be disassembled and assembled, making replacement of the rotor 4 possible with little outlay.

The power steering system 1 may also be referred to as an EPAS system, wherein the spherical electric motor 2 supports, where necessary, steering movements of a driver of the motor vehicle with a force generated by the spherical electric motor 2. The transmission power or force in the power steering system is not fixed to a specific transmission configuration or mechanism. The transmission can directly engage, or via at least one further component indirectly engage, the steering column or the tie rod. The motor vehicle can be a car, a bus or a truck.

According to one embodiment, an obtuse angle α is arranged between an axis of rotation of the rotor 13 of the electric motor 2 and an axis of symmetry of the stator 14 of the electric motor 2. The stator is arranged asymmetrically with respect to the axis of rotation 13 of the rotor 4 or a shaft driven with it.

A further embodiment includes the transmission having a worm gear including a worm wheel 7 connected in a rotationally conjoined manner to the steering column and a worm 9 connected in a rotationally conjoined manner to the rotor 4 of the electric motor 2. A stationary bearing guides a shaft portion 10, of the worm 9, arranged facing away from the electric motor 2. This configuration of the power steering system 1 requires only one radial bearing, in particular, a radial anti-friction bearing or a radial plain bearing, rotatably supporting the shaft portion 10. The bearing can also have the function of an axial bearing. The worm wheel 7 can connect directly, or via at least one further component, for example, a bushing or the like, in a rotationally conjoined manner to the steering column. The worm 9 includes a further portion 11 on a side faces the rotor 4. The worm 9 includes a portion 12 having a screw thread formed thereon. In one embodiment, the transmission 6 can be formed as a steering rack gear and a steering rack that can be connected to the tie rod, or be formed as a tie rod, and a worm 9 connected in a rotationally conjoined manner to the rotor 4 of the electric motor 2, wherein the shaft portion 10, arranged facing away from the electric motor 2, is guided on a stationary bearing. Only one radial bearing is needed to realize this configuration of the power steering system 1, in particular, a radial anti-friction bearing or a radial plain bearing, is necessary to rotatably bear the shaft portion.

According to another embodiment, the power steering system 22 includes a housing 23 connected to the stator 3 of the electric motor 2. The housing 23 encloses a portion of the rotor 4 of the electric motor 2 and has a housing opening 24 through which at least one component of the transmission 6 runs. The housing 23 protects the spherical electric motor 2 from contaminants in the region of the connection between the stator 3 and the rotor 4 increasing the durability of the spherical electric motor 2. With a worm gear, the threaded portion 12 of the worm 9 and a shaft portion 10 of the worm 9 of the worm gear extends outward past the housing opening 24.

The housing 23 may be connected to the stator 3 using a mechanical connection, for example, an interference fit or force-fit manner, a bayonet fitting, or a threaded connection. In one embodiment, the housing 23 may be screwed onto the stator 3 or otherwise connected to the stator 3. Because the exemplary mechanical connections can be released in a destruction-free manner, simple mounting and dismounting of the housing 23 is possible.

The position of the stator 3 is variable relative to the housing 23 along the axis of symmetry 14 of the stator 3, wherein the housing 23 is formed so the angle between the axis of rotation 13 of the rotor 4 of the electric motor 2 and the axis of symmetry 14 of the stator 3 of the electric motor 2 can be varied by a variation of the position of the stator 3 relative to the housing 23. Varying the position of the stator 3 relative to the housing 23, along the axis of symmetry 14 or longitudinal central axis of the stator 3 adjusts or restricts the angle between the axis of rotation 13 of the rotor 4 and the axis of symmetry 14 of the stator 3. Adjustment of the angle generates or changes a pretensioning force with which, for example, the worm 9 is pressed against a worm wheel 7. A stated angular setting, spatial adjustment or alignment of the components of the transmission at or to one another is possible.

Another embodiment includes the power steering system having at least one control electronics 15 for controlling the electric motor, wherein the control electronics are fastened to the stator 3 of the electric motor 2. The electric motor 2, together with the control electronics 15, form a space-saving structural unit. The power steering system 1 may include an electric sensor detecting steering movements of the driver of the motor vehicle, generating signals corresponding to the steering movements, and sending them to the control electronics 15. The control electronics 15 processing these signals to generate corresponding control signals for the electric motor 2 so that desired steering assistance is possible.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A power steering system for a motor vehicle, having an electric motor and a transmission drivingly connecting said electric motor a steering component of said power steering system wherein the electric motor is a spherical motor having a spherical rotor and a semi-spherical stator.

2. The power steering system of claim 1 including an axis of rotation of said rotor and an axis of symmetry of said stator arranged at an obtuse.

3. The power steering system of claim 1 wherein said transmission includes a worm drive having a worm wheel connected to a steering column and a worm gear connected to said rotor and mounted on a shaft, said shaft supported on a stationary bearing.

4. The power steering system of claim 1 wherein said transmission includes a worm drive and a steering rack connected to a tie rod, said worm drive having a worm gear connected to said rotor and mounted on a shaft, said shaft supported on a stationary bearing, and said worm gear engaging said steering rack.

5. The power steering system of claim 1 including a housing connected to said stator and enclosing a portion of said rotor, said housing having a housing opening through which at least one component of said transmission runs.

6. The power steering system of claim 5 wherein said housing is connected to said stator with an interference fit.

7. The power steering system of claim 5 wherein a position of the housing relative to said stator along an axis of symmetry of the stator is variable, so varying the position of the housing relative to the stator varies the angle between an axis of rotation of the rotor and said axis of symmetry of the stator.

8. The power steering system of claim 1 including control electronics for controlling the electric motor, wherein the control electronics are fastened to the stator of the electric motor.

9. The power steering system of claim 5 wherein said housing is connected to said stator with a threaded connection.

10. A power steering system comprising:
a steering component;
a spherical electric motor including a stator having a stator axis of rotation and a rotor having a rotor axis of rotation, said stator axis of rotation and said rotor axis of rotation configured at an obtuse angle; and
a worm drive including a worm wheel connected to the steering component and a worm gear connected to a rotor of the electric motor.

11. The power steering system of claim 10 wherein including a shaft connected to said rotor, said worm gear positioned on said shaft between a bearing and said rotor.

12. The power steering system of claim 10 wherein said stator includes a ball pin and a bearing ball, said rotor rotatably mounted on said bearing ball.

13. The power steering system of claim 11 including a housing connected to said stator, said housing encloses a portion of said rotor; and
said housing having a housing opening through which a portion of said shaft extends.

14. The power steering system of claim 13 including an interference fit between said housing and said stator.

15. The power steering system of claim 13 including a bayonet fit between said housing and said stator.

16. The power steering system of claim 13 wherein a position of the housing relative to the stator, along the axis of symmetry of the stator, is variable; and
wherein said varying the position of said housing on said stator varies the angle between the axis of rotation of the rotor and the axis of symmetry of the stator.

17. The power steering system of claim 10 wherein said stator is a semi-spherical stator and said rotor is a spherical rotor.

18. A power steering system comprising:
a steering component;
a spherical electric motor including a stator having a stator axis of rotation and a rotor having a rotor axis of rotation, said stator axis of rotation and said rotor axis of rotation configured at an obtuse angle;
a worm drive including a worm wheel connected to the steering component and a worm gear connected to a rotor of the electric motor;
including a housing connected to said stator, said housing encloses a portion of said rotor; and
wherein a position of the housing relative to the stator, along the axis of symmetry of the stator, is variable; and
wherein said varying the position of said housing on said stator varies the angle between the axis of rotation of the rotor and the axis of symmetry of the stator.
